(19) United States
(12) Patent Application Publication
(10) Pub. No.: US 2004/0112621 A1
(43) Pub. Date: Jun. 17, 2004

(54) Easy installation sub-grade conduit connector

(76) Inventors: Peter Schengrund, Berkeley Heights, NJ (US); Joseph Curcio, Berkeley Heights, NJ (US)

Correspondence Address: PHARMACEUTICAL PATENT ATTORNEYS, POHL & ASSOC., 55 MADISON AVENUE, 4TH FLOOR, ATTN: MARK POHL (P 4014), MORRISTOWN, NJ, 07960-6397, US

(21) Appl. No.: 10/319,072

(22) Filed: Dec. 11, 2002

(51) Int. Cl. H02G 3/04

(52) U.S. Cl. 174/48

(57) ABSTRACT

An electrical conduit connector particularly suited for connecting angled or elbowed conduit in a constrained space.

This is an improved electrical conduit connector.

There are no Federal rights in this invention.

### BACKGROUND

Electrical cable, when laid in an area subject to physical disruption or insult (such as in the ground), is typically protected by housing the electrical cable in an outer protective shell or conduit. Conduit is commercially available, as are connectors which connect sections of conduit together.

Prior art connectors work well where the connector installation site is not physically confined. Where, however, the conduit connector must be installed in a physically-confined site, prior art conduit connectors can be difficult to install. The prior art connectors which are able to be installed with elbowed conduit, by contrast, use pressure fittings, which in practice are difficult to connect.

For example, along roadways, electrical lines can be laid in sub-grade trench. Installing a conventional conduit connector in a trench is difficult in the best conditions, requiring rotating or screwing the conduit pieces in situ in the trench, to attach the conduit into the connector. Where, however, the trench bends or curves, the conduit must also bend or curve to conform to the trench. In this situation, the bent conduit cannot be rotated, because conduit rotation is restricted by the trench. This makes rotating the conduit impossible.

We have developed an electrical conduit connector device that is easier to install, even where the conduit is placed in confined areas or used with curved conduit sections.

### BRIEF DESCRIPTION OF THE DRAWINGS

FIG. 1 is an isometric view of the connector used with two elbowed conduit sections.

FIG. 2 is an isometric view of the connector used with two elbowed conduit sections.

FIG. 3 is an isometric view of the connector used with two straight conduit sections, showing the electrical cable housed in the conduit.

FIG. 4 is an isometric view of a half of the connector.

FIG. 5 is a top of the connector.

FIG. 6 is a bottom view of the connector.

FIG. 7 is a side view of the connector.

FIG. 8 is an opposite side view of the connector.

FIG. 9 is a front view of the connector.

FIG. 10 is an alternate front view of the connector.

FIG. 11 is an isometric view of an alternative embodiment of the connector itself.

FIG. 12 is an isometric view of an alternative embodiment of the connector itself.

FIG. 13 is an isometric view of an alternative embodiment of the connector itself.

FIG. 14 is an isometric view of the connector itself.

### DETAILED DESCRIPTION

We first discuss the components of the connector, and then discuss how to make our connector, and then discuss how to install our connector to join elbowed conduit sections.

### Components

We prefer to make our connector using galvanized steel. Steel offers high strength and thus offers a reliable protective environment for the electrical cable. Its high tensile strength also means the threading will be adequately durable to hold the connected electrical conduit sections together. Steel is also electrically conductive; conductivity can be important because it assures the sections of metal conduit connected using our connector, will form a contiguous grounded environment for the electrical cable. Galvalization is important for use where the conduit is exposed to humidity (for example, in an exterior trench).

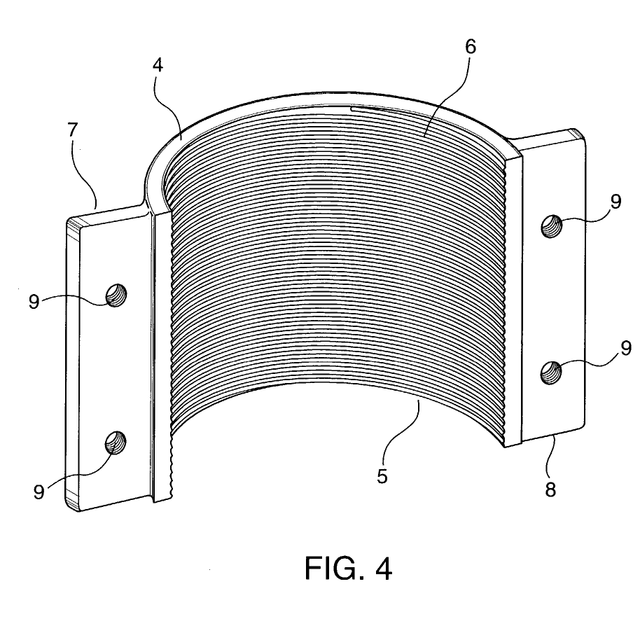

The connector is assembled from pieces shown in FIG. 4. We prefer to make our connector starting with galvanized steel pipe with an inside diameter of approximately ½″ (or greater). This kind of pipe is commercially available from a number of construction supply companies. We cut this pipe into 3¼″ long segments. The resulting segments are 1½″ inside diameter cylinders, with a 3¼″ length. We call the two ends of the 3¼″ length cylinder the “upstream” and the “downstream” ends, respectively. This cylinder must be threaded on the inside surface of each of the upstream and the downstream ends. One may tap the threads into each of the two ends. Alternatively, one may tap completely along the 3¼″ length, or even cut 3¼″ sections from 1½″ inside diameter steel pipe which is already tapped along its length; this is a choice based on economics and convenience.

Each segment is then cut along the entire length of the pipe from upstream end to downstream end, cutting through the center of the diameter, to make two equal sized halves. This creates two half-cylinders. Because the form of each of these halves describes half of a cylinder, we call these shapes “hemi-cylinders.”

FIG. 4 shows the hemi-cylinder [4] has threads [6] disposed on its interior concave face [5]. FIG. 4 shows these threads continuing from the upstream end to the downstream end. This is not absolutely necessary; it suffices to have threads at the upstream end and at the downstream end: threads may, but need not, be in the middle portion of the cylinder length.

In use, two of these hemi-cylinders must be joined together. We prefer to join them together using a plate-and-bolt configuration. To make this, we start with 1″×¼″ galvanized steel stock. We first tap a plurality of screw threads along the length of the stock. This stock is then cut into segments, each one about the same length as are the pipe stock segments. We then weld one of these pieces of stock onto each side of the pipe stock halves.

The complete piece is therefore shown in FIG. 4. The 1″×¼″ steel stock [7, 8] has a plurality of screw holes [9] tapped into it. One piece of steel stock [7, 8] is welded onto each of the two linear ends of the hemi-cylindrical pipe stock [4].

### The Connector

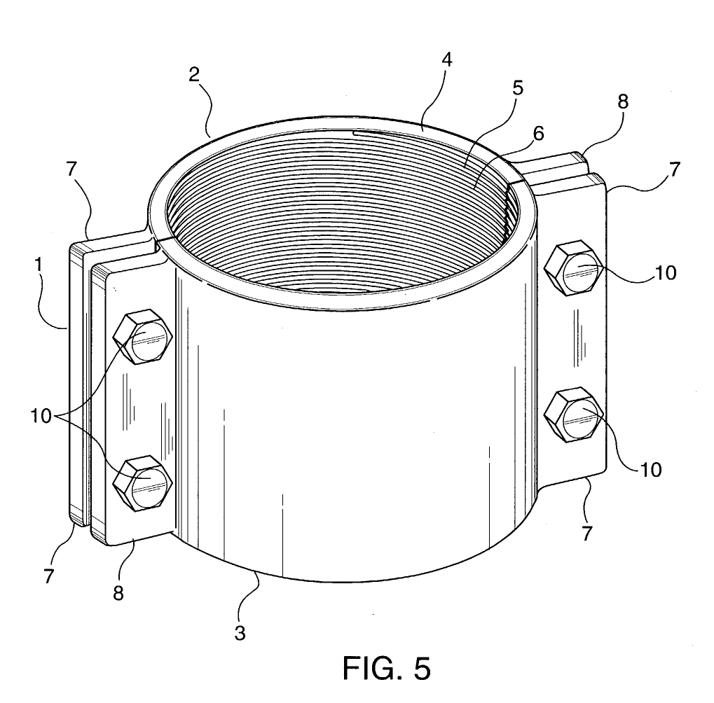

Two of these hemi-cylindrical halves are put together to make a complete connector. This is shown in FIG. 5.

FIG. 5 shows the electrical conduit connector [1] assembled (but without any conduit disposed within it). The connector [1] is assembled from a first hemi-cylinder [2] and a second hemi-cylinder [3]. The hemi-cylinders [2, 3] are metal and therefore able to conduct electricity.

The first hemi-cylinder [2] has a convex outer face [4] and a concave inner face [5]. The concave inner face [5] has threads [6]. The threads [6] are arrayed to match threads [c] disposed on the outer convex face [d] of electrical conduit. The second hemi-cylinder [3] is configured similarly.

Each hemi-cylinder [2, 3] has plate stock [7, 8] welded along the straight edge of the hemi-cylinder. The plate stock [7, 8] has holes tapped into it (shown as element [9] in FIG. 4). The two hemi-cylinders are attached to each other by bolts [10] extending through one piece of plate stock [7] into the other piece of plate stock [8].

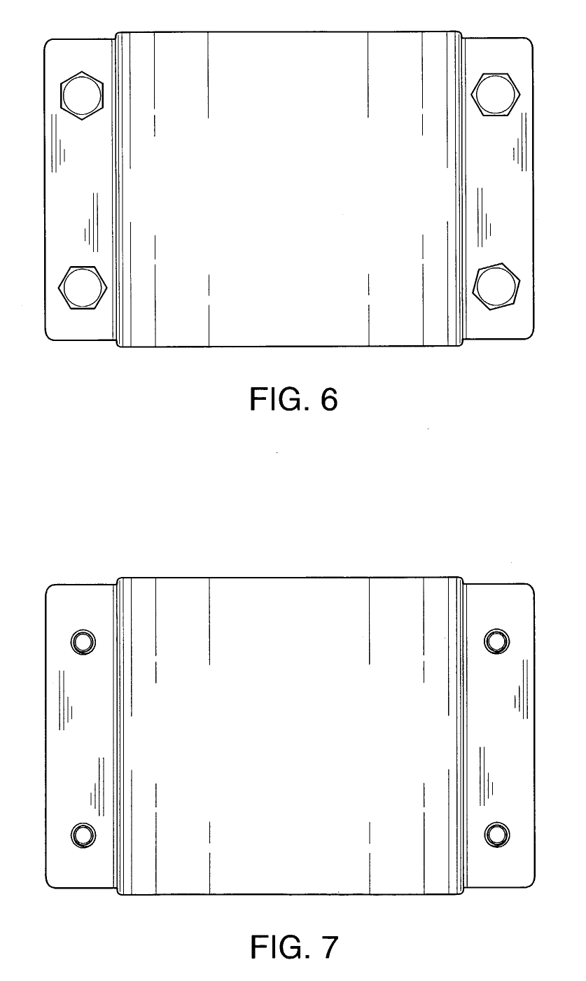

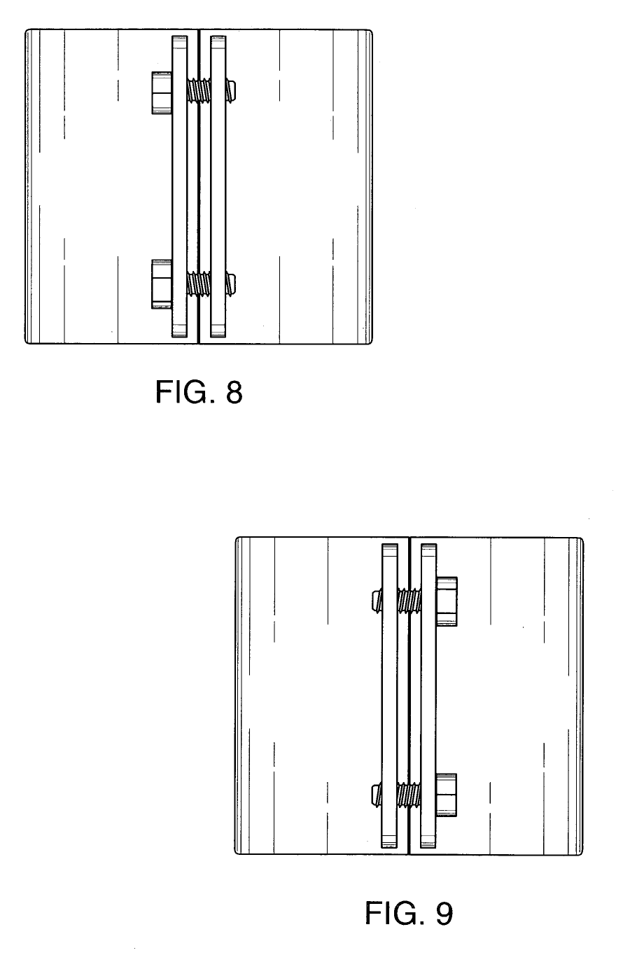

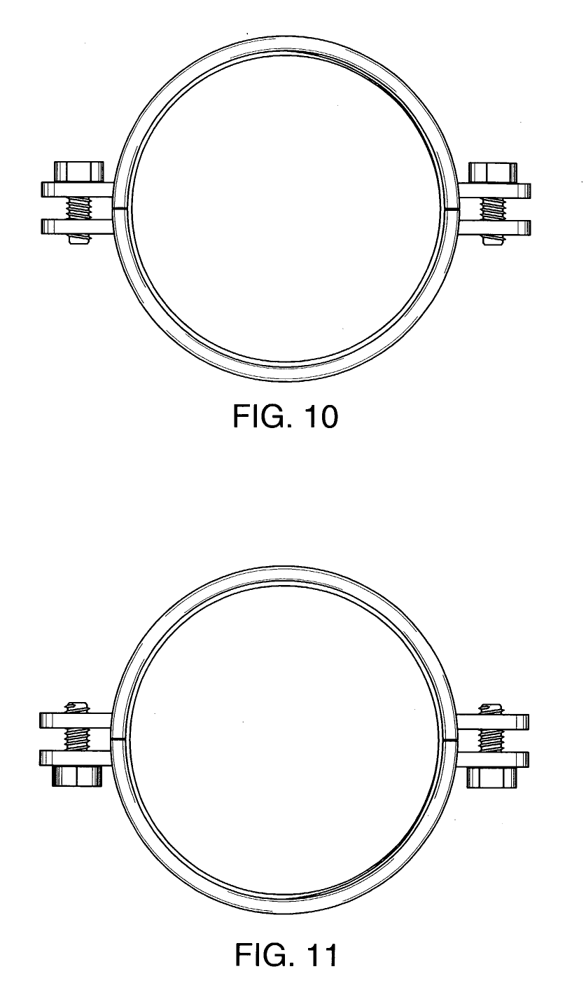

This configuration is illustrated in top view in FIG. 6, in bottom view in FIG. 7, side views in FIG. 8 and FIG. 9, and front-end and rear-end views in FIG. 10 and FIG. 11.

These figures collectively, then, show the two halves of the connector assembled together. They show, however, the connector without any conduit disposed between the halves. These figures, then, illustrate the connector itself, but do not show how the connector is in fact typically used.

### Using the Connector

In practice, the two hemi-cylindrical halves are assembled about two sections of conduit to be connected, before being attached to each other.

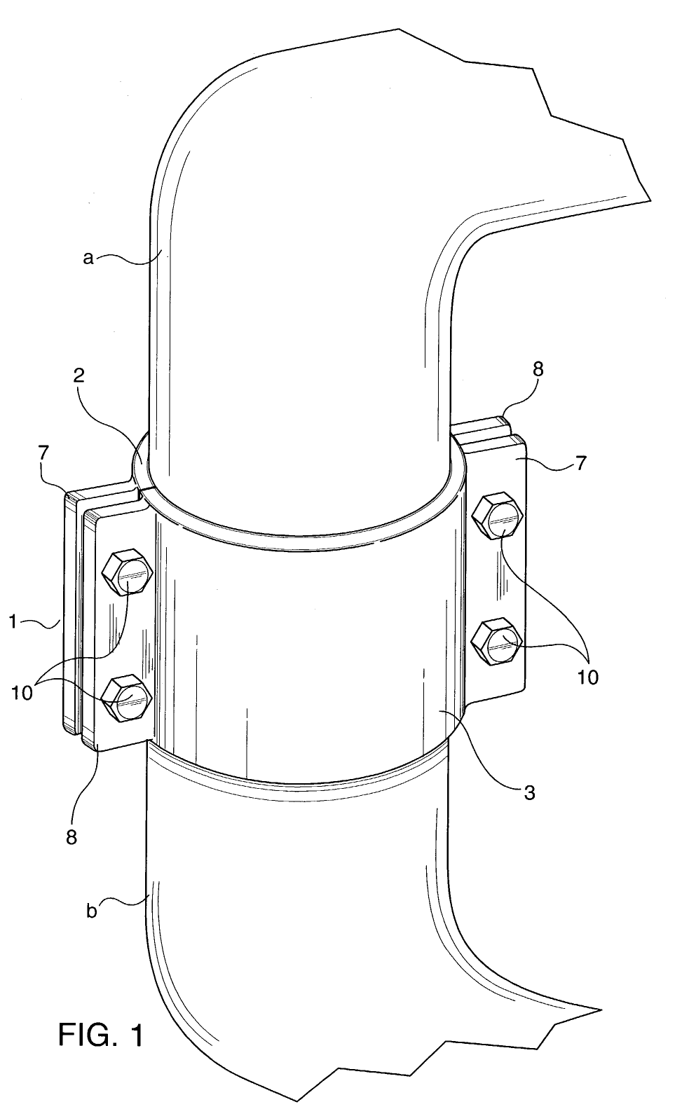

This is shown in FIG. 1. FIG. 1 shows an isometric view of the complete connector [1], installed about sections of electrical conduit [a, b]. Note the sections of electrical conduit [a, b] are elbowed. In an above-ground installation site, it may be possible to assemble the connector in isolation, and then insert the conduit sections [a, b] into the connector by rotating or screwing the conduit sections [a, b] into the connector.

Where the installation space is constricted, however (such as in a sub-grade trench), there may not be enough space to rotate the elbowed conduit and screw it into the connector. In this situation, the conduit sections [a, b] are placed in position first, and the two hemi-cylindrical [2, 3] halves are then assembled about the conduit sections [a, b], whereby the threads [6] disposed on the concave interior surface [5] of the hemi-cylindrical pieces [2, 3] match and fit into the threads [c] disposed on the convex exterior surface [d] of the conduit sections [a, b]. The two hemi-cylindrical pieces [2, 3] are then attached to each other by screwing bolts [10] through the threaded holes [9] in the steel stock [7, 8] attached to the hemi-cylindrical pieces [2, 3].

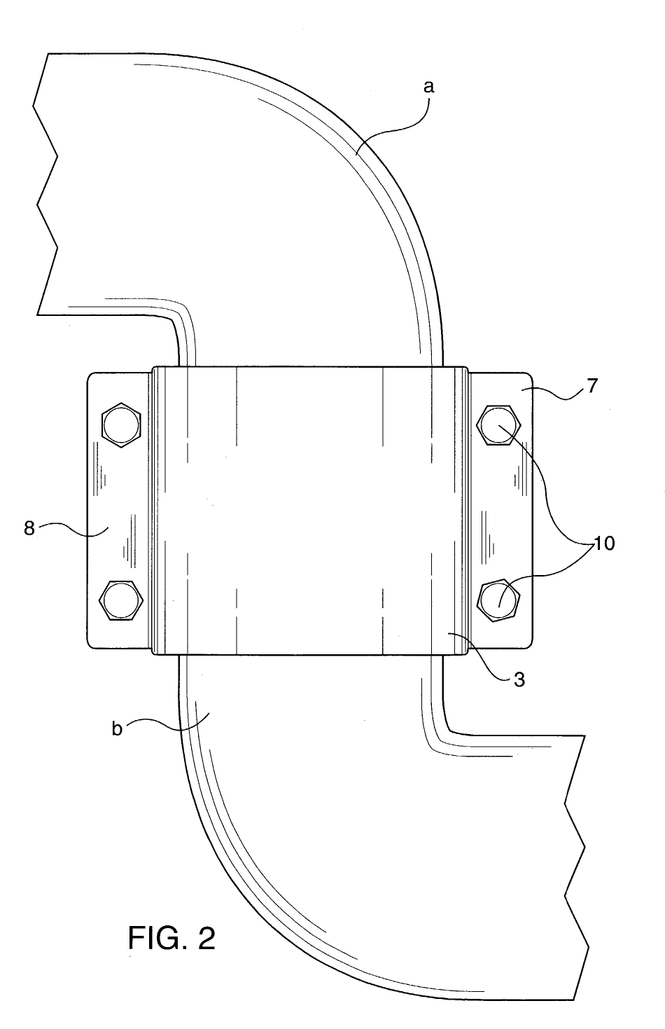

FIG. 2 shows a top view of the connector [1] so installed about sections of electrical conduit [a, b] which are elbowed. In this example, the entire connector [1] is made of metal, and thus can conduct electricity from conduit section [a] to section [b]. This assures the various sections of conduit are adequately grounded.

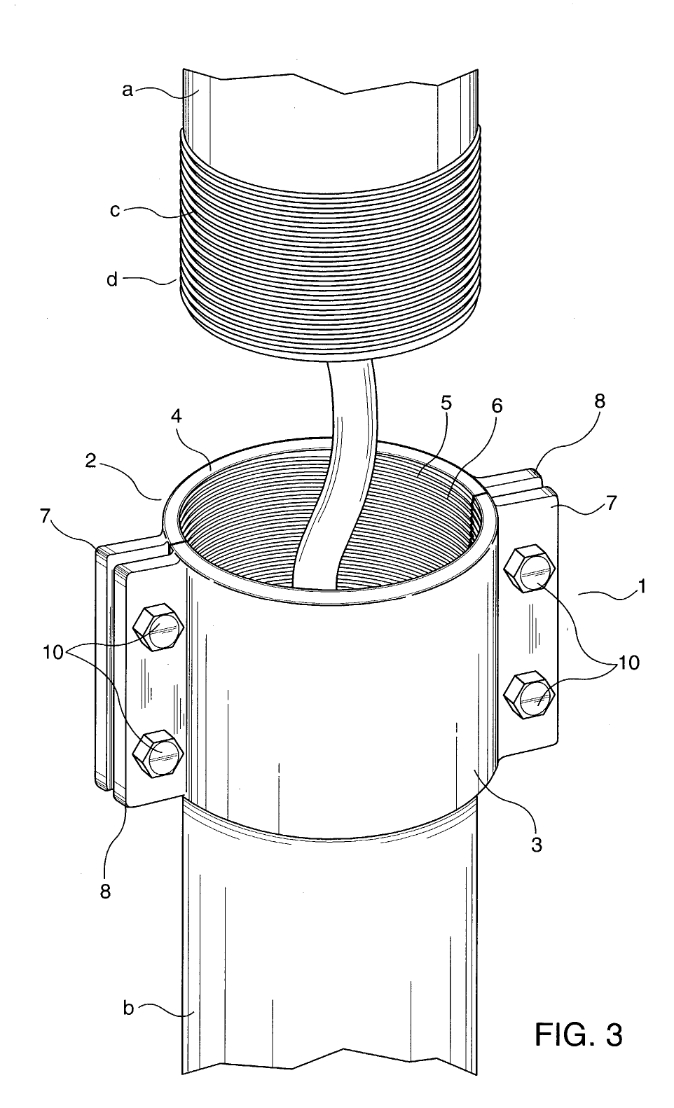

FIG. 3 shows the connector connected about one section of electrical conduit [b], with a second section of conduit [a] unconnected. The first [2] and second [3] hemi-cylinder fit together about the electrical conduit [b], whereby each hemi-cylinder [2, 3] has a concave inner face [5] with threads [6] that match the threads disposed on the outer convex face of the section of electrical conduit [b], thereby gripping the threads disposed on the outer convex face of the electrical conduit [b]. the unattached section of conduit [a] has threads [c] disposed on its outer convex face [c]; these threads [c] can similarly match with the threads [6] on the hemi-cylinders [2, 3] inner concave face [5].

### Attaching the Halves

We prefer to attach the two hemi-cylinders [2, 3] to each other using bolts [10]. We prefer to use two bolts [10] per side, as shown in, for example, FIG. 1. Other attachments are, however possible.

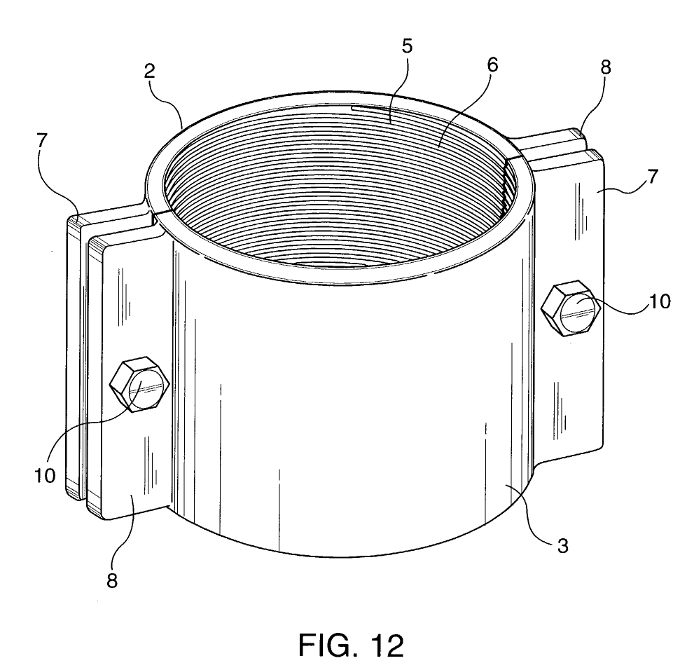

For example, FIG. 12 shows an embodiment using only one bolt [10] per side. This embodiment may be less expensive to manufacture and faster (and therefore less expensive) to install in situ. The lower strength realized with only one bolt [10] may prove immaterial, where the connector is not subject to dynamic nor static load, or where such load is carried by, for example, concrete poured around the connector.

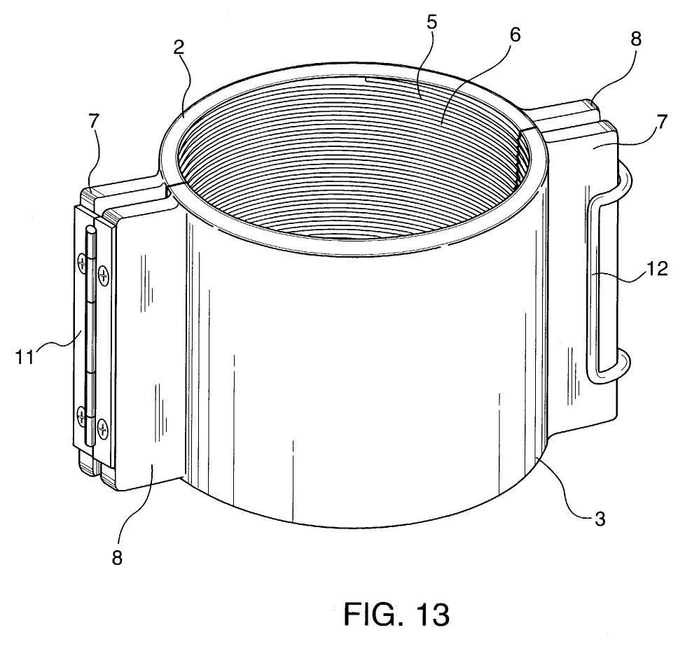

Another example is shown in FIG. 13. FIG. 13 shows an embodiment using not bolts [10], but a hinge [11] and clasp [12]. This embodiment appears more expensive to manufacture, but much faster (and therefore less expensive) to install in situ. As with the alternative shown in FIG. 12, the lower strength realized with a hinge-and-clasp configuration may prove immaterial, where the connector is not subject to dynamic nor static load, or where such load is carried by, for example, concrete poured around the connector.

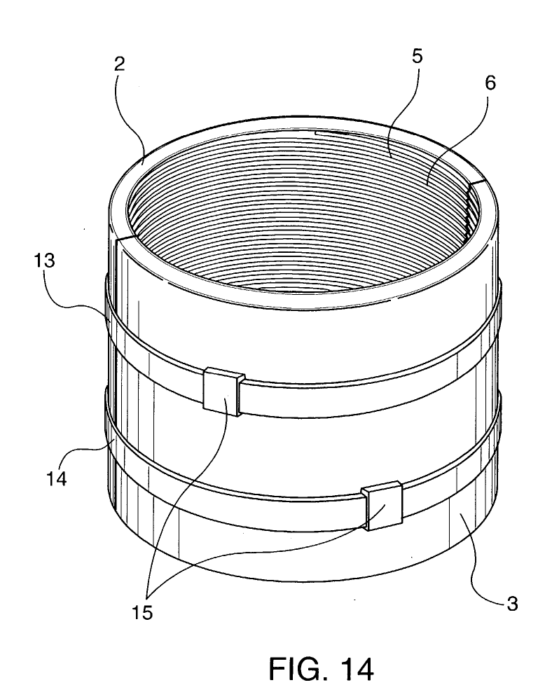

Another example is shown in FIG. 14. FIG. 14 shows an embodiment wherein the hemi-cylinders are connected using one or more bands [13, 14], each cinctured about the connector and held in place with a clasp [15]. This embodiment is significantly less expensive to manufacture, but may be more difficult to install in situ. This is because banding is typically a rapid process, but the confined space of a trench may prove inconvenient for using many conventional banding tools. Furthermore, the hemi-cylinders may be difficult for the installer to manually hold in place, where the installer does not have bolt holes to afford a quick manner to hold the two halves. As with the alternative shown in FIG. 12 and FIG. 13, the lower strength realized with a band-and-clasp configuration may prove immaterial where the connector is not subject to dynamic nor static load, or where such load is carried by, for example, concrete poured around the connector.

### Conclusion

It will become apparent to one of skill in the art that our invention may be modified to create connectors which vary from the examples discussed herein, but still fall within the spirit and scope of our invention as claimed. For example, the two hemi-cylindrical pieces may be joined inexpensively and permanently by tack welding, rather than by using removable bolts or bands. Alternatively, where corrosion resistance is more important than providing an electrical ground, the connector (and the conduit) could be made from polyvinyl chloride pipe, rather than steel.

Thus, while we discuss our preferred embodiment in detail, we intend the legal coverage of our patent to be defined not by the specific examples we discuss, but by the claims appended here.

We claim:

1. An electrical conduit connector comprising:
a. a first hemi-cylinder having a concave inner face with an upstream end and a downstream end,
said upstream end having threads arrayed to match threads disposed on an outer convex face of an upstream electrical conduit,
said downstream end having threads arrayed to match threads disposed on an outer convex face of a downstream electrical conduit; and
b. a second hemi-cylinder having a concave inner face with an upstream end and a downstream end,
said upstream end having threads arrayed to match threads disposed on said outer convex face of said upstream electrical conduit,
said downstream end having threads arrayed to match threads disposed on said outer convex face of said downstream electrical conduit; and
c. an attachment for attaching said first hemi-cylinder to said second hemi-cylinder to form a cylinder.

2. The connector of claim 1, wherein at least one of said hemi-cylinders is able to conduct electricity between said upstream electrical conduit and said downstream electrical conduit.

3. The connector of claim 2, further comprising an elbowed upstream electrical conduit having an outer convex face having threads, said threads engaging said threads disposed on said upstream end of said inner convex face of said first and second hemi-cylinders.

4. The connector of claim 2, wherein said attachment comprises:
a first plate extending along the length of said first hemi-cylinder, said first plate having a first hole disposed therein, and
a second plate extending along the length of said second hemi-cylinder, said second plate having a second hole disposed therein, whereby a bolt can traverse from said first hole into said second hole, whereby said first hemi-cylinder and said second hemi-cylinder are attached.

5. A method comprising using the connector of claim 2 to connect an upstream electrical conduit to a downstream electrical conduit.

6. The method of claim 5, wherein at least one of said upstream electrical conduit and said downstream electrical conduit is elbowed.

7. The method of claim 5, wherein said electrical conduit is located in a sub-grade trench.

8. The method of claim 5, wherein at least one of said upstream electrical conduit and said downstream electrical conduit is elbowed.

9. An electrical conduit connector comprising two halves dimensioned to together form a connector having an interior concave surface with a downstream end and an upstream end, said interior concave surface downstream end and said interior concave surface upstream end each bearing threads disposed thereon, each said half bearing along its length a plate having at least one hole suitable for inserting a bolt.
